(19) United States
(12) Patent Application Publication
(10) Pub. No.: US 2008/0111753 A1
(43) Pub. Date: May 15, 2008

(54) Dual band printed antenna and dual band printed antenna module

(75) Inventor: Shih-Chieh Cheng, Tainan County (TW)

Correspondence Address: BIRCH STEWART KOLASCH & BIRCH, PO BOX 747, FALLS CHURCH, VA, 22040-0747, US

(73) Assignee: Arcadyan Technology Corporation

(21) Appl. No.: 11/882,040

(22) Filed: Jul. 30, 2007

(30) Foreign Application Priority Data
Nov. 9, 2006 (TW) 095141494

(51) Int. Cl. H01Q 1/38

(52) U.S. Cl. 343/767; 343/700 MS

(57) ABSTRACT

A dual band printed antenna includes a first metal sheet, a second metal sheet, a substrate and a conductive unit. The first metal sheet is triangular and has a slit and a feeding part. The slit is extended from a side to another side of the first metal sheet. The slit and the feeding part divide the first metal sheet into a first radiating part and a second radiating part. The second metal sheet has a breach and a grounding part. The breach is triangular and located opposite to the first metal sheet. The first and second metal sheets are disposed on the substrate. The first metal sheet is apart a distance from the second metal sheet. The conductive unit has a conductive body, which is electronically connected with the feeding part, and a grounding body, which is electronically connected with the grounding part. A dual band printed antenna module is also disclosed.

### BACKGROUND OF THE INVENTION

1. Field of Invention

The invention relates to a printed antenna and, in particular, to a dual band printed antenna and a dual band printed antenna module.

2. Related Art

The rapidly developed radio transmission has brought various products and technologies applied in the field of multi-band transmission, such that many new products have the performance of radio transmission to meet the consumer's requirement. The antenna is an important element for transmitting and receiving electromagnetic wave energy in the radio transmission system. If the antenna is lost, the radio transmission system cannot transmit and receive data. Thus, the antenna plays an indispensable role in the radio transmission system.

Selecting a proper antenna can match the feature of the product, enhance the transmission property, and further reduce the product cost. Different methods and different materials for manufacturing the antennas are used in different application products. In addition, considerations have to be taken when the antenna is designed according to different frequency bands used in different countries.

With reference to FIG. 1, a conventional printed antenna includes a substrate 11, a radiating part 12, and a transmitting part 13. The radiating part 12 is formed on the surface of the substrate 11, and has a central radiating unit 121 and two radiating arms 122, 123. The radiating arms 122, 123 are disposed symmetrically on the two sides of the central radiating unit 121, so that an electromagnetic coupling effect is induced between the radiating arms 122, 123 and the central radiating unit 121. The transmitting part 13 is electrically coupled to the central radiating unit 121 and the radiating arms 122, 123 for transmitting signals. The central radiating unit 121 operates in a low-frequency band, whereas the radiating arms 122, 123 operate in a high-frequency band.

Generally speaking, the printed antenna 1 is a highly sensitive antenna. Its dual band function may be lost due to errors in the size of the radiating arms 122, 123 or the distance between radiating arms 122, 123 and the central radiating unit 121. Besides, the radiating part 12 has a nontrivial geometric shape. When the substrate 11 is a print circuit board (PCB) and is formed with a plurality of electronic devices, there is limitation in the position of the radiating part 12 on the substrate 11. For example, it can only be disposed around the center of the substrate 11, instead of corners thereof. In this situation, the printed antenna 1 is susceptible to the influence of its surrounding electronic devices, such as capacitors and other high-frequency electronic devices, reducing the efficiency of the printed antenna 1. On the other hand, the corner space of the substrate 11 is usually less used. If the radiating part 12 can be disposed at one of the corners, then other electronic devices can be disposed at other locations of the substrate 11. This can achieve the effects of reducing the substrate size and the production cost.

Therefore, it is an important subject of the invention to provide an antenna with stable dual operating bands and functions. Moreover, such an antenna makes good use of the corner space of the PCB or substrate to enhance its overall efficiency and lower the manufacturing cost.

### SUMMARY OF THE INVENTION

In view of the foregoing, the invention is to provide a dual band printed antenna with two operating bands and making good use of the corner space, and a dual band printed antenna module including a plurality of the dual band antennas.

To achieve the above, the invention discloses a dual band printed antenna including a first metal sheet, a second metal sheet, a substrate and a conductive unit. The first metal sheet is triangular and has a slit and a feeding part. The slit is extended from one side to another side of the first metal sheet. The slit and feeding part divide the first metal sheet into a first radiating part and a second radiating part. The second metal sheet has a breach and a grounding part. The breach is triangular and located opposite to the first metal sheet. The first and second metal sheets are disposed on the substrate. The first metal sheet is apart a distance from the second metal sheet. The conductive unit has a conductive body, which is electronically connected with the feeding part, and a grounding body, which is electronically connected with the grounding part.

To achieve the above, the invention also discloses a dual band printed antenna module including a plurality of first metal sheets, a plurality of second metal sheets, and a plurality of conductive units. Each first metal sheet is triangular and has a slit and a feeding part. The slit is extended from one side to another side of the first metal sheet. The slit and feeding part divide the first metal sheet into a first radiating part and a second radiating part. Each second metal sheet has a breach and a grounding part. The breach is triangular and located opposite to the first metal sheet. Each first metal sheet is apart a distance from the corresponding second metal sheet. Each conductive unit has a conductive body, which is electronically connected with the feeding part, and a grounding body, which is electronically connected with the grounding part.

As mentioned above, the first metal sheet of the disclosed dual band printed antenna or dual band printed antenna module is triangular. Therefore, the dual band printed antenna and dual band printed antenna module can be disposed at a corner of the substrate. Besides, the slit divides the first metal sheet into a first radiating part and a second radiating part. The first radiating part operates in a first frequency band, and the second radiating part in a second frequency band. The first and second bands are compliant with IEEE 802.11b/g and IEEE 802.11a, respectively. Therefore, the dual band printed antenna and dual band printed antenna module are capable of stabilizing the dual operating bands. Moreover, the corner space is best utilized to increase the overall efficiency of the antenna and reduce the cost thereof.

### BRIEF DESCRIPTION OF THE DRAWINGS

The invention will become more fully understood from the detailed description given herein below illustration only, and thus is not limitative of the present invention, and wherein:

FIG. 1 is a schematic view of the conventional antenna;

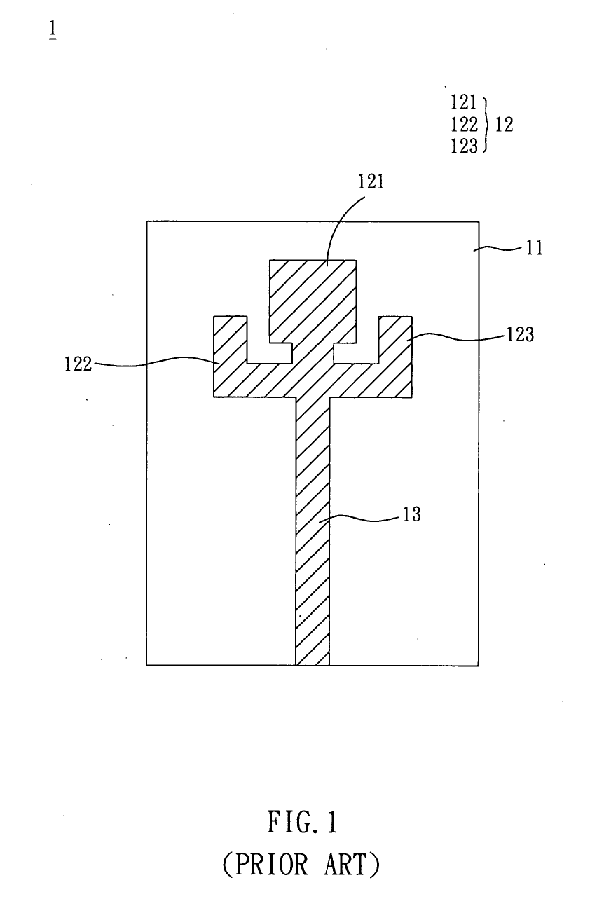

FIG. 2 is a schematic view of a dual band printed antenna according to a preferred embodiment of the invention;

FIG. 3 shows the measurements of the VSWR in the operating frequency range of the dual band printed antenna according to the preferred embodiment of the invention;

FIG. 4 show the H-plane radiation fields of the dual band printed antenna operating at the frequencies of 2.4 GHz;

FIG. 5 show the H-plane radiation fields of the dual band printed antenna operating at the frequencies of 2.45 GHz;

FIG. 6 show the H-plane radiation fields of the dual band printed antenna operating at the frequencies of 4.9 GHz;

FIG. 7 show the H-plane radiation fields of the dual band printed antenna operating at the frequencies of 5.35 GHz;

FIG. 8 show the H-plane radiation fields of the dual band printed antenna operating at the frequencies of 5.75 GHz;

FIG. 9 show the H-plane radiation fields of the dual band printed antenna operating at the frequencies of 5.85 GHz; and

FIG. 10 is a schematic view of a dual band printed antenna module according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

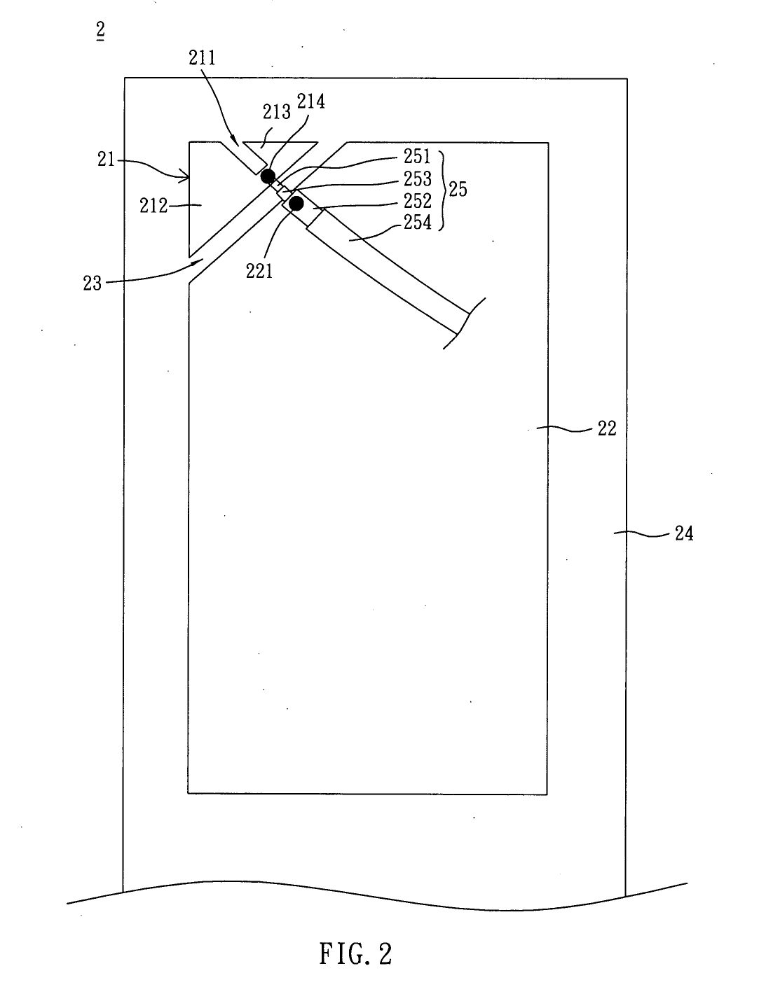

As shown in FIG. 2, the dual band printed antenna 2 in a preferred embodiment of the invention includes a first metal sheet 21 and a second metal sheet 22. The first metal sheet 21 is triangular and has a slit 211 extending from one side of the first metal sheet 21 to another side. The slit divides the first metal sheet 21 into a first radiating part 212 and a second radiating part 213. In this embodiment, the first metal sheet 21 is a right triangle. The width of the slit 211 is between 2 mm and 4 mm. The area of the first radiating part 212 is larger than that of the second radiating part 213. Besides, the first metal sheet 21 has a feeding part 214. In this embodiment, the feeding part 214 is formed at one end of the slit 211, and the slit 211 and feeding part 214 divide the first metal sheet 21 into a first radiating part 212 and a second radiating part 213.

The second metal sheet 22 is rectangular and has a breach located at one corner of the second metal sheet 22. The breach is disposed opposite to the first metal sheet 21. The first metal sheet 21 is apart a distance 23 from the second metal sheet 22. In this embodiment, the distance 23 is smaller than 5 mm. Moreover, the second metal sheet 22 further has a grounding part 221, which is disposed opposite to the feeding part 214.

Besides, the dual band printed antenna 2 has a substrate 24 for the first metal sheet 21 and the second metal sheet 22 to be disposed thereon. In this embodiment, the substrate 24 is a PCB. Besides, the first metal sheet 21 is triangular. Therefore, the dual band printed antenna 2 is preferably disposed in the corner space of the substrate 24. Thus, the dual band printed antenna 2 is less affected by other electronic devices, such as inductors, capacitors, or high-frequency devices disposed around it in prior art.

The dual band printed antenna 2 further has a conductive unit 25 with a conducting body 251 and a grounding body 252. The conducting body 251 is electrically coupled to the feeding point 214 of the first metal sheet 21. The grounding body 252 is electrically coupled to the grounding point 221 of the second metal sheet 22. Moreover, the conductive unit 25 has a first insulating layer 253 and a second insulating layer 254. The first insulating layer 253 is disposed between the conducting body 251 and the grounding body 252 as an insulator. The second insulating layer 254 is disposed at the outermost layer of the conductive unit 23 for insulation and protection. In this embodiment, the conductive unit 25 is a coaxial cable.

According to the embodiment, the first radiating part 212 operates in a first frequency band, and the second radiating part 213 in a second frequency band. The first frequency band is compliant with IEEE 802.11b/g, roughly between 2.4 GHz and 2.5 GHz. The second frequency band is compliant with IEEE 802.11a, roughly between 4.9 GHz and 6 GHz.

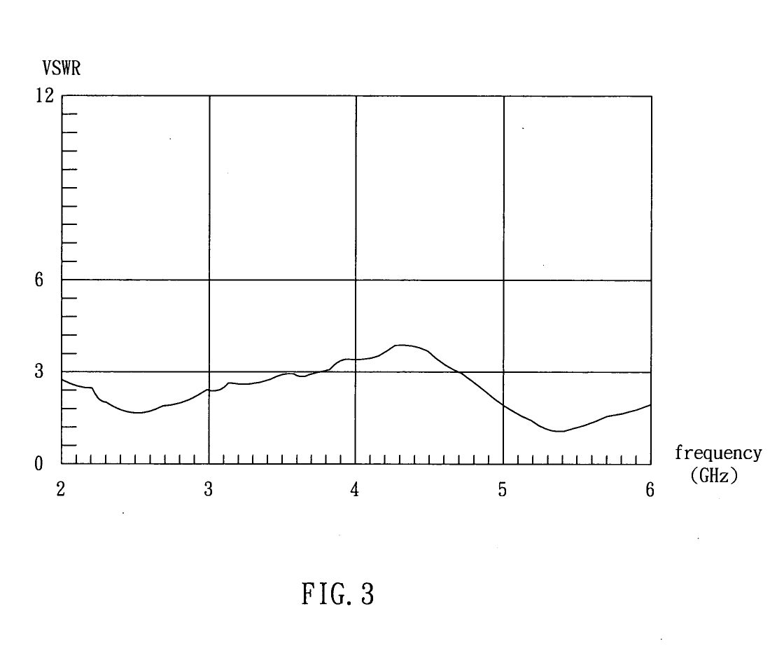

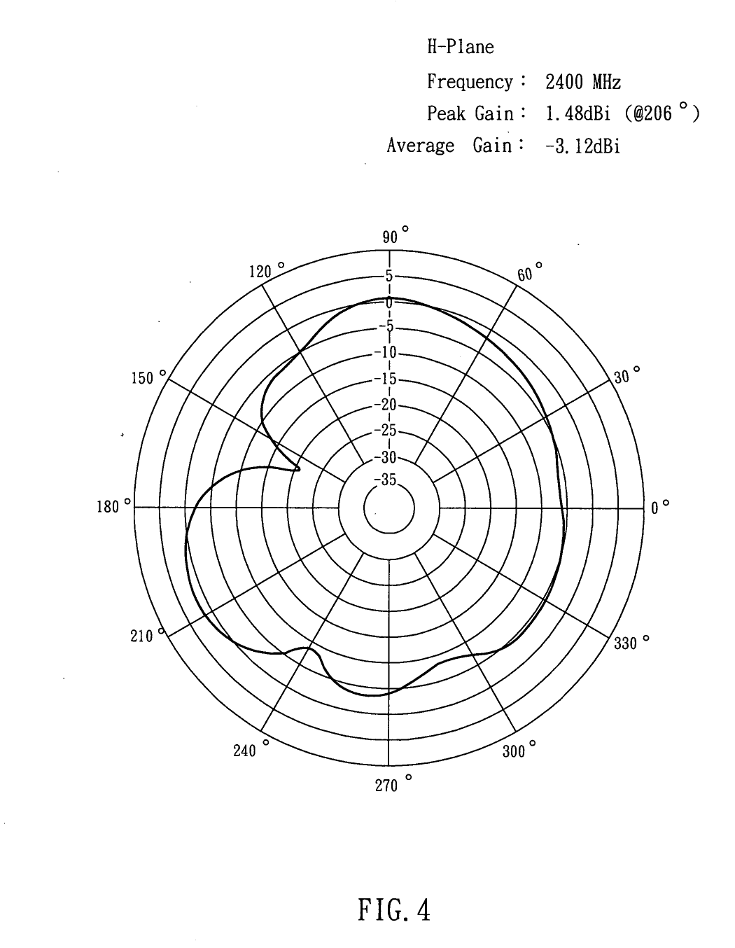

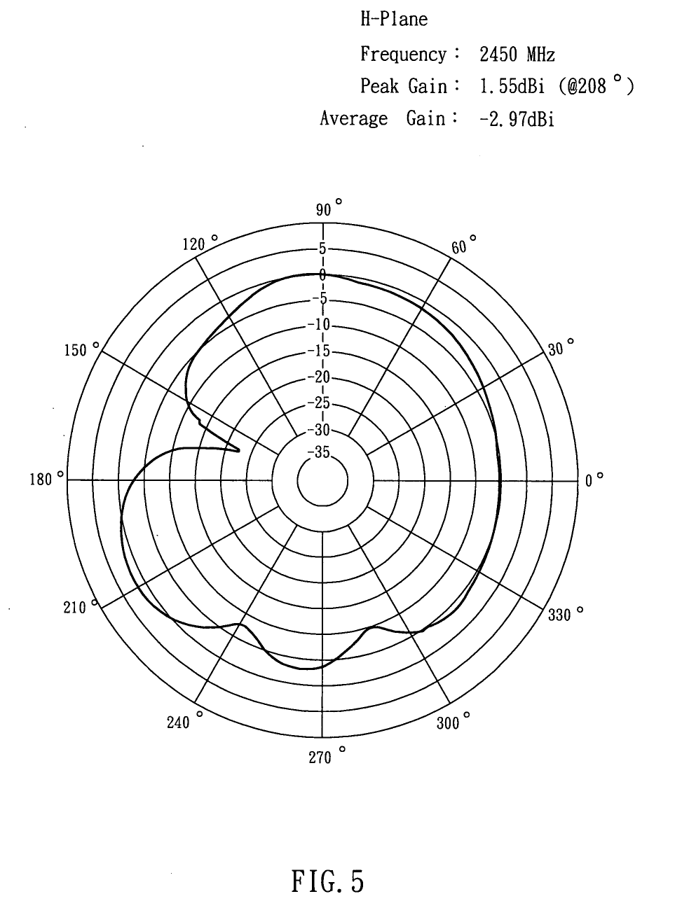

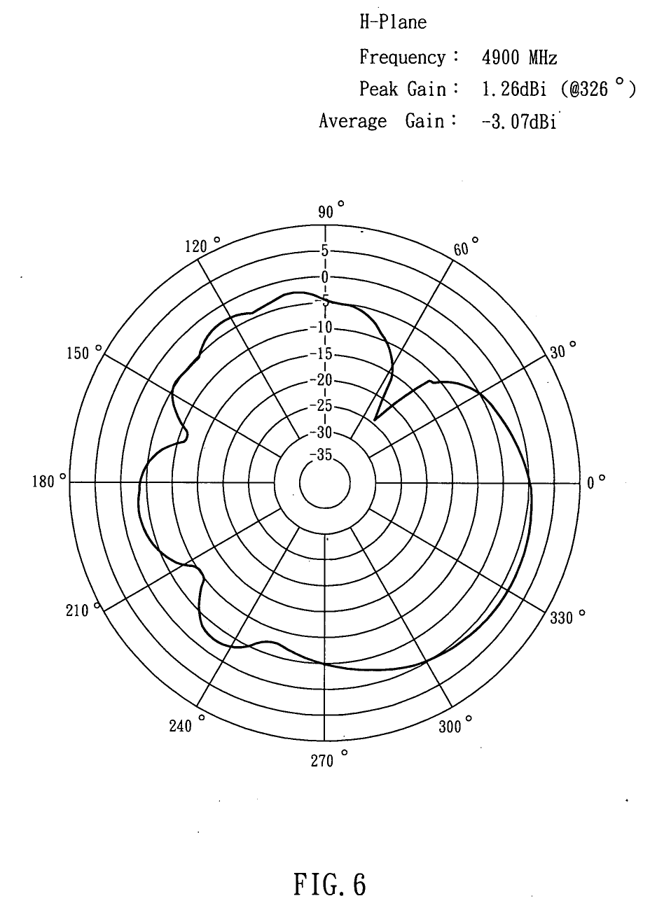

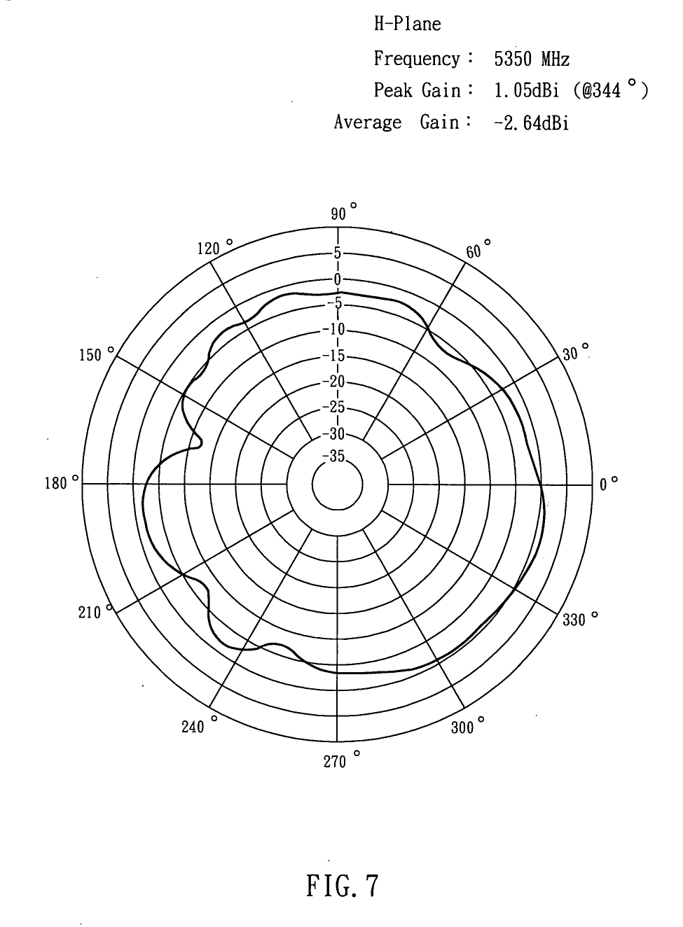

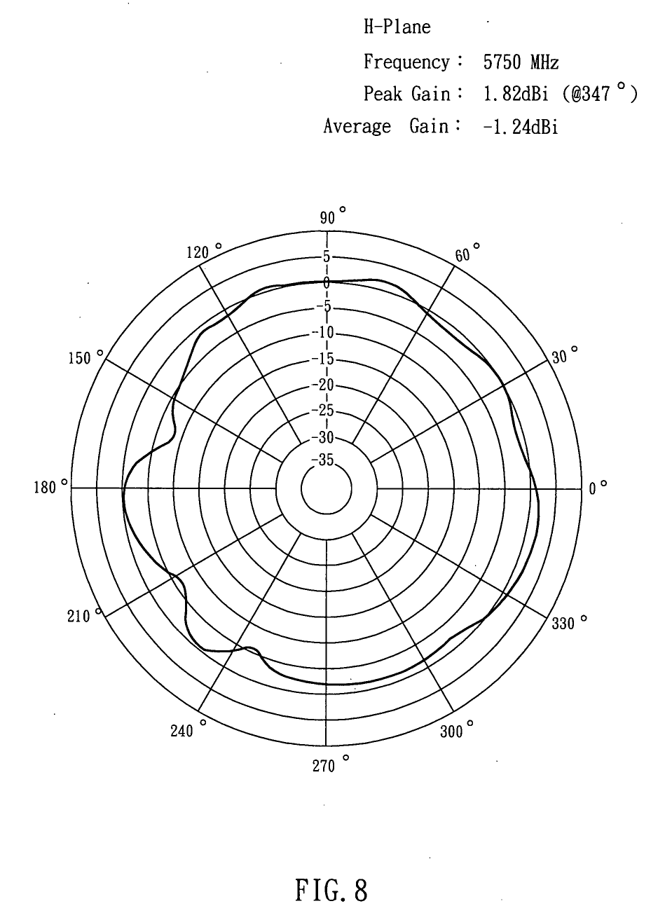

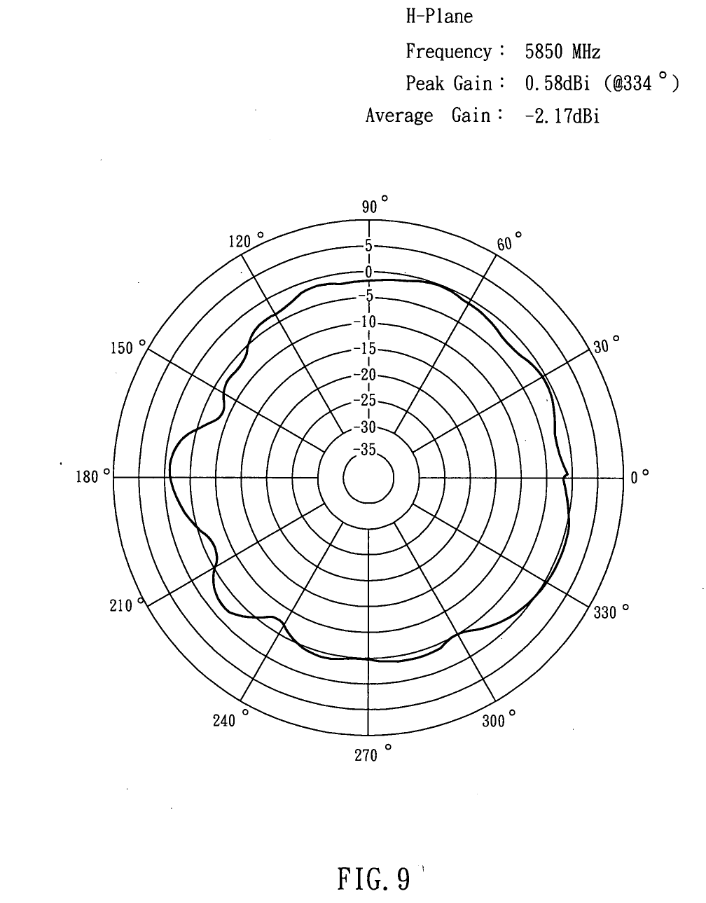

As shown in FIG. 3, the vertical axis is the voltage-standing wave ratio (VSWR), and the horizontal axis is frequency. According to the definition of the acceptable VSWR of 2 used in the industry, it is seen that the dual band printed antenna 2 according to the preferred embodiment of the invention can operate between 2.4 GHz and 2.5 GHz and between 4.9 GHz and 6 GHz. Besides, FIGS. 4 to 9 show the results of measured H-plane radiation fields for the disclosed dual band printed antenna 2 operating at the frequencies of 2.4 GHz, 2.45 GHz, 4.9 GHz, 5.35 GHz, 5.75 GHz, and 5.85 GHz. As shown in FIG. 4, the maximum gain of the dual band printed antenna 2 operating at the frequency of 2.4 GHz is 1.48 dBi, and the gain average thereof is −3.12 dBi (at 206°). As shown in FIG. 5, the maximum gain of the dual band printed antenna 2 operating at the frequency of 2.45 GHz is 1.55 dBi, and the gain average thereof is −2.97 dBi (at 208°). As shown in FIG. 6, the maximum gain of the dual band printed antenna 2 operating at the frequency of 4.9 GHz is 1.26 dBi, and the gain average thereof is −3.07 dBi (at 326°). As shown in FIG. 7, the maximum gain of the dual band printed antenna 2 operating at the frequency of 5.35 GHz is 1.05 dBi, and the gain average thereof is −2.64 dBi (at 344°). As shown in FIG. 8, the maximum gain of the dual band printed antenna 2 operating at the frequency of 5.75 GHz is 1.82 dBi, and the gain average thereof is −1.24 dBi (at 347°). As shown in FIG. 9, the maximum gain of the dual band printed antenna 2 operating at the frequency of 5.85 GHz is 0.58 dBi, and the gain average thereof is −2.17 dBi (at 334°).

A dual band printed antenna module according to a preferred embodiment of the invention includes a plurality of first metal sheets, a plurality of second metal sheets, and a plurality of conductive units. A set of a first metal sheet, a second metal sheet, and a conductive unit is defined as a dual band printed antenna.

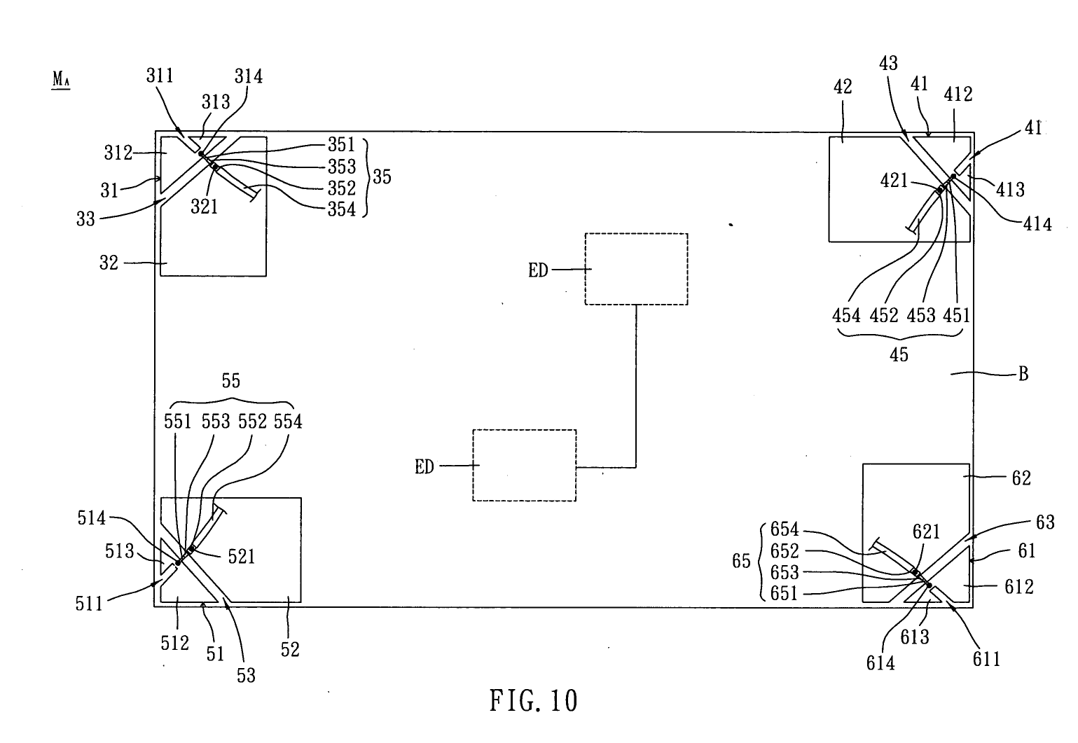

With reference to FIG. 10, a dual band printed antenna module MA includes a first dual band printed antenna 3, a second dual band printed antenna 4, a third dual band printed antenna 5, and a fourth dual band printed antenna 6, which are disposed at four corners of a substrate B, respectively. Thus, the dual band printed antenna module MA is less affected by other electronic devices ED, such as inductors, capacitors, or high-frequency devices disposed around it in prior art.

The first dual band printed antenna 3 includes a first metal sheet 31, a second metal sheet 32, and a conductive unit 35. The first metal sheet 31 has a slit 311 and a feeding part 314, which divide the first metal sheet 31 into a first radiating part 312 and a second radiating part 313. The first metal sheet 31 is apart a distance 33 from the second metal sheet 32. The second metal sheet 32 has a grounding part 321. The conductive unit 35 has a conductive body 351, a grounding body 352, a first insulating layer 353, and a second insulating layer 354.

The second dual band printed antenna 4 includes a first metal sheet 41, a second metal sheet 42, and a conductive unit 45. The first metal sheet 41 has a slit 411 and a feeding part 414, which divide the first metal sheet 41 into a first radiating part 412 and a second radiating part 413. The first metal sheet 41 is apart a distance 43 from the second metal sheet 42. The second metal sheet 42 has a grounding part 421. The conductive unit 45 has a conductive body 451, a grounding body 452, a first insulating layer 453, and a second insulating layer 454.

The third dual band printed antenna 5 includes a first metal sheet 51, a second metal sheet 52, and a conductive unit 55. The first metal sheet 51 has a slit 511 and a feeding part 514, which divide the first metal sheet 51 into a first radiating part 512 and a second radiating part 513. The first metal sheet 51 is apart a distance 53 from the second metal sheet 52. The second metal sheet 52 has a grounding part 521. The conductive unit 55 has a conductive body 551, a grounding body 552, a first insulating layer 553, and a second insulating layer 554.

The fourth dual band printed antenna 6 includes a first metal sheet 61, a second metal sheet 62, and a conductive unit 65. The first metal sheet 61 has a slit 611 and a feeding part 614, which divide the first metal sheet 61 into a first radiating part 612 and a second radiating part 613. The first metal sheet 61 is apart a distance 63 from the second metal sheet 62. The second metal sheet 62 has a grounding part 621. The conductive unit 65 has a conductive body 651, a grounding body 652, a first insulating layer 653, and a second insulating layer 654.

The structures and relative locations of the first metal sheets 31, 41, 51, 61, the second metal sheets 32, 42, 52, 62, the conductive units 35, 45, 55, 65, the slits 311, 411, 511, 611, the feeding parts 314, 414, 514, 614, the first radiating parts 312, 412, 512, 612, the second radiating parts 313, 413, 513, 613, the distances 33, 43, 53, 63, and the grounding parts 321, 421, 521, 621 of this embodiment are the same as those of the first metal sheet 21, the second metal sheet 22, the conductive unit 25, the slit 211, the feeding part 214, the first radiating part 212, the second radiating part 213, the distance 23, and the grounding part 221 of the dual band printed antenna 2 in the previous embodiment, so the detailed descriptions are omitted.

As mentioned above, the dual band printed antenna module MA of this embodiment employs the dual band printed antennas 3, 4, 5, and 6. This achieves the effects of spatial and radiation field redistribution, reducing correlation among various channels in space, and increasing the transmission rate in each channel.

In summary, the first metal sheet of the disclosed dual band printed antenna or dual band printed antenna module is triangular. Therefore, the dual band printed antenna and dual band printed antenna module can be disposed at a corner of the substrate. Besides, the slit divides the first metal sheet into a first radiating part and a second radiating part. The first radiating part operates in a first frequency band, and the second radiating part in a second frequency band. The first and second bands are compliant with IEEE 802.11b/g and IEEE 802.11a, respectively. Therefore, the dual band printed antenna and dual band printed antenna module are capable of stabilizing the dual operating bands. Moreover, the corner space is best utilized to increase the overall efficiency of the antenna and reduce the cost thereof.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A dual band printed antenna, comprising:
a first metal sheet, which has a slit and a feeding part, wherein the slit extends from one side of the first metal sheet to another side of the first metal sheet, the slit and the feeding part divide the first metal sheet into a first radiating part and a second radiating part;
a second metal sheet, which has a grounding part and is disposed opposite to the first metal sheet, wherein the first metal sheet is apart a distance from the second metal sheet;
a substrate, wherein the first metal sheet and the second metal sheet are disposed on the substrate; and
a conductive unit, which has a conductive body electronically connected with the feeding part, and a grounding body electronically connected with the grounding part.

2. The dual band printed antenna of claim 1, wherein the width of the slit is between 2 mm and 4 mm, the distance is smaller than 5 mm, and the first metal sheet is triangular.

3. The dual band printed antenna of claim 1, wherein the second metal sheet is rectangular with a triangular breach located at one corner of the rectangular second metal sheet.

4. The dual band printed antenna of claim 1, wherein the feeding part is located at one end of the slit of the first metal sheet and the feeding part is disposed opposite to the grounding part.

5. The dual band printed antenna of claim 1, wherein an area of the first radiating part is larger than an area of the second radiating part.

6. The dual band printed antenna of claim 1, wherein the first radiating part operates in a first frequency band and the first frequency band is compliant with IEEE 802.11b/g and the first frequency band is between 2.4 GHz and 2.5 GHz.

7. The dual band printed antenna of claim 1, wherein the second radiating part operates in a second frequency band, the second frequency band is compliant with IEEE 802.11a, and the second frequency band is between 4.9 GHz and 6 GHz.

8. The dual band printed antenna of claim 1, wherein the conductive unit further has a first insulating layer and a second insulating layer, the first insulating layer is disposed between the conductive body and the grounding body, and the second insulating layer is a surface layer of the conductive unit.

9. The dual band printed antenna of claim 1, wherein the conductive unit is a coaxial cable.

10. The dual band printed antenna of claim 1, wherein the substrate is a print circuit board (PCB).

11. A dual band printed antenna module, comprising:
a plurality of first metal sheets, wherein each of the first metal sheets has a slit and a feeding part, the slit extends from one side of the first metal sheet to another side of the first metal sheet, the slit and the feeding part divide the first metal sheet into a first radiating part and a second radiating part;
a plurality of second metal sheets, wherein each of the second metal sheets has a grounding part and is disposed opposite to the first metal sheet, and the first metal sheet is apart a distance from the second metal sheet; and
a plurality of conductive units, wherein each of the conductive units has a conductive body electronically connected with the feeding part, and a grounding body electronically connected with the grounding part.

12. The dual band printed antenna module of claim 11, wherein the width of the slit is between 2 mm and 4 mm, the distance is smaller than 5 mm, and each of the first metal sheets is triangular.

13. The dual band printed antenna module of claim 11, wherein each of the second metal sheets is rectangular with a triangular breach located at one corner of the rectangular second metal sheet.

14. The dual band printed antenna module of claim 11, wherein, in each of the first metal sheets, the feeding part is located at one end of the slit the feeding parts are disposed opposite to the grounding parts, respectively.

15. The dual band printed antenna module of claim 11, wherein, in each of the first metal sheets, an area of the first radiating part is larger than an area of the second radiating part.

16. The dual band printed antenna module of claim 11, wherein each of the first radiating parts operates in a first frequency band, the first frequency band is compliant with IEEE 802.11b/g, and the first frequency band is between 2.4 GHz and 2.5 GHz.

17. The dual band printed antenna module of claim 11, wherein each of the second radiating parts operates in a second frequency band, the second frequency band is compliant with IEEE 802.11a, and the second frequency band is between 4.9 GHz and 6 GHz.

18. The dual band printed antenna module of claim 11, wherein each of the conductive units further has a first insulating layer and a second insulating layer, the first insulating layer is disposed between the conductive body and the grounding body, and the second insulating layer is a surface layer of the conductive unit.

19. The dual band printed antenna module of claim 11, wherein each of the conductive units is a coaxial cable.

20. The dual band printed antenna module of claim 11, further comprising a substrate, wherein the first metal sheets and the second metal sheets are disposed on the substrate.

21. The dual band printed antenna module of claim 20, wherein the substrate is a print circuit board (PCB).
